(19) United States
(12) Patent Application Publication
(10) Pub. No.: US 2005/0111390 A1
(43) Pub. Date: May 26, 2005

(54) Signaling method, server and gateway terminal

(75) Inventor: Yoshikazu Kobayashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC INFRONTIA CORPORATION

(21) Appl. No.: 10/991,615

(22) Filed: Nov. 19, 2004

(30) Foreign Application Priority Data
Nov. 20, 2003 (JP) 2003-390859

(51) Int. Cl. H04L 12/28; H04L 12/66; H04B 1/44

(52) U.S. Cl. 370/282; 370/401

(57) ABSTRACT

When a server has received an Invite Request for a telephone connected to a public telephone line, the server transfers the Invite Request to a gateway terminal. Upon receiving the Invite Request, the gateway terminal originates a call to the telephone. The server inserts a telephone number of the telephone into one of an area other than an area assigned for a URI of the gateway terminal within a start-line of the Invite Request, an area other than the start-line of the Invite Request, and a message other than the Invite Request. The gateway terminal reads out the telephone number of the telephone from one of the area other than an area assigned for a URI of the gateway terminal within a start-line of the Invite Request, the area other than the start-line of the Invite request and the message other than the Invite request and then originates, in a call origination step, a call to the telephone by using the telephone number that has been read out in a readout step.

### BACKGROUND OF THE INVENTION

1. Field of the Invention

The present invention relates to a signaling method for establishing a telephone communication link, and more specifically, to a signaling method for establishing a telephone communication link between a terminal connected to an IP (Internet Protocol) network such as the Internet or intranet and a telephone set connected to a public telephone network.

2. Description of the Related Art

An SIP (Session Initiation Protocol), which has been developed for inviting a user to a certain session, is used for establishing, changing, or disconnecting a multimedia session on the Internet.

Conventionally, two signaling methods have been used for establishing communication between a terminal (“user agent” in terms of the SIP) connected to the Internet and a telephone set connected to a public telephone network.

FIG. 1 shows a configuration of a system that implements the first signaling method and a sequence of the signaling method.

Referring to FIG. 1, when a terminal 901 makes a call to a telephone 904, firstly, the terminal 901 sends an Invite Request 911 to an SIP redirect server 902. The to-line of the header field in the Invite Request 911 describes “0312341234@domin.com” obtained by combining “0312341234”, which is a telephone number of the telephone 904 and “domin.com”, which is a name of a domain that the terminal 901, SIP redirect server 902 and an SIP gateway server 903 belong to.

Upon receiving the Invite Request 911, the SIP redirect server 902 sends back a reply 912 including an address of the SIP gateway server 903 to the terminal 901.

Upon receiving the reply 912, the terminal 901 sends an Invite Request 914 to the SIP gateway server 903. As is the case with the Invite Request 911, the start-line of the Invite Request 914 describes URL of the gateway server 903, and the to-line of the header field describes “0312341234@domin.com”.

When receiving the Invite Request 914, the SIP gateway server 903 reads out “0312341234” from “0312341234@domin.com” described in the header field of the Invite Request 914, connects to a public telephone network, and makes a call to the telephone 904 whose telephone number is “0312341234” (915).

FIG. 2 shows a configuration of a system that implements the second signaling method and a sequence of the signaling method.

Referring to FIG. 2, when the terminal 901 makes a call to the telephone 904, firstly, the terminal 901 sends an Invite Request 921 to an SIP proxy server 905. The to-line of the header field in the Invite Request 921 describes “0312341234@domin.com” obtained by combining “0312341234”, which is a telephone number of the telephone 904 and “domin.com”, which is a name of a domain that the terminal 901, SIP proxy server 905 and SIP gateway server 903 belong to.

Upon receiving the Invite Request 921, the SIP proxy server 905 sends an Invite Request 922 to the SIP gateway server 903 based on the expectation that the SIP gateway server 903 can handle the destination indicated by the to-line of the header field in the Invite Request 922. The header field in the Invite Request 922 also describes “0312341234@domin.com”.

Upon receiving the Invite Request 922, the SIP gateway server 903 reads out “0312341234” from “0312341234@domin.com” described in the header field of the Invite Request 922, connects to a public telephone network, and makes a call to the telephone 904 whose telephone number is “0312341234” (923).

The following documents can be taken as conventional art documents related to the present invention. RFC 3261 written standards (http://www.ietf.org/rfc/rfc3261.txt) relates to an SIP; RFC 2327 written standards (http://www.ietf.org/rfc/rfc2327.txt?number=2327) relates to an SDP (Session Description Protocol) concerning contents described in the body of an SIP message; RFC 3550 written standards (http://rfc3550.x42.com/) relates to an RTCP (Real time Control Protocol) for controlling transmission of an RTP (Real Time Packet); and “How to Add MSN Messenger Services for PC-to-Phone Functionality to Cisco Packet Voice Networks (http://www.cisco.com/warp/public/cc/techno/tyvdve/sip/prodlit/mpcph_wp.htm)” relates to the abovementioned two signaling methods.

To implement the aforementioned two signaling methods, the SIP gateway server must be used. The SIP gateway server is a device that has an SIP server function and gateway function. Since the SIP server function part is expensive, the SIP gateway server is an expensive product to use.

### SUMMARY OF THE INVENTION

An object of the present invention is to provide a signaling method that allows a communication connection between a terminal connected to an IP network and a telephone set connected to a public telephone network to be established without the use of an SIP gateway server, and a server and gateway terminal for use in the method.

According to a first aspect of the present invention, there is provided a signaling method comprising: a transfer step in which, when having received an Invite Request for a telephone connected to a public telephone network, a server transfers the Invite Request to a gateway terminal; and a call origination step in which, when having received at least the Invite Request, the gateway terminal originates a call to the telephone.

The signaling method according to the first aspect of the present invention may further comprise: a readout step in which the server reads out a telephone number of the telephone from the received Invite Request; an insertion step in which the server inserts a URI of the gateway terminal into a start-line of the received Invite Request; and an insertion step in which the server inserts the telephone number of the telephone into one of an area other than an area assigned for the URI of the gateway terminal within the start-line of the Invite Request to be sent to the gateway terminal, an area other than the start-line of the Invite Request to be sent to the gateway terminal, and a message to be sent to the gateway terminal other than the Invite Request sent to the gateway terminal.

The signaling method according to the first aspect of the present invention may further comprise a readout step in which the gateway terminal reads out the telephone number of the telephone from one of the start-line of the Invite Request received from the server, the area other than the start-line, and the message received from the server other than the Invite Request from the server, wherein the gateway terminal originates, in the call origination step, a call to the telephone by using the telephone number that has been read out in the readout step.

The signaling method according to the first aspect of the present invention may further comprise an insertion step in which the server inserts the telephone number of the telephone into the start-line of the header in the Invite Request to be sent to the gateway terminal.

The signaling method according to the first aspect of the present invention may further comprise a readout step in which the gateway terminal reads out the telephone number of the telephone from the start-line of the header in the Invite Request received from the server, wherein the gateway terminal originates, in the call origination step, a call to the telephone by using the telephone number that has been read out in the readout step.

The signaling method according to the first aspect of the present invention may further comprise an insertion step in which the server inserts the telephone number of the telephone into a header field of the Invite Request to be sent to the gateway terminal.

The signaling method according to the first aspect of the present invention may further comprise a readout step in which the gateway terminal reads out the telephone number of the telephone from the header field of the Invite Request received from the server, wherein the gateway terminal originates, in the call origination step, a call to the telephone by using the telephone number that has been read out in the readout step.

The signaling method according to the first aspect of the present invention may further comprise an insertion step in which the server inserts the telephone number of the telephone into a body of the Invite Request to be sent to the gateway terminal.

The signaling method according to the first aspect of the present invention may further comprise a readout step in which the gateway terminal reads out the telephone number of the telephone from the body of the Invite Request received from the server, wherein the gateway terminal originates, in the call origination step, a call to the telephone by using the telephone number that has been read out in the readout step.

The signaling method according to the first aspect of the present invention may further comprise an insertion step in which the server inserts the telephone number of the telephone into an acknowledge request to be sent to the gateway terminal.

The signaling method according to the first aspect of the present invention may further comprise a readout step in which the gateway terminal reads out the telephone number of the telephone from the acknowledge request received from the server, wherein the gateway terminal originates, in the call origination step, a call to the telephone by using the telephone number that has been read out in the readout step. The signaling method according to the first aspect of the present invention may further comprise an insertion step in which the server inserts the telephone number of the telephone into a Real Time Control Protocol packet to be sent to the gateway terminal.

The signaling method according to the first aspect of the present invention may further comprise a readout step in which the gateway terminal reads out the telephone number of the telephone from the Real Time Control Protocol packet received from the server, wherein the gateway terminal originates, in the call origination step, a call to the telephone by using the telephone number that has been read out in the readout step.

According to a second aspect of the present invention, there is provided a server comprising: receiving means for receiving an Invite Request for a telephone connected to a public telephone network; and a transfer means for transferring the Invite Request to a gateway terminal when the server has received the Invite Request.

The server according to the second aspect of the present invention may further comprise a readout means for reading out a telephone number of the telephone from the received Invite Request; a first insertion means for inserting a URI of the gateway terminal into a start-line of the received Invite Request; a second insertion means for inserting the telephone number of the telephone into one of an area other than an area assigned for the URL of the gateway terminal within the start-line of the Invite Request to be sent to the gateway terminal, an area other than the start-line of the Invite Request to be sent to the gateway terminal, and a message to be sent to the gateway terminal other than the Invite Request sent to the gateway terminal.

In the server according to the second aspect of the present invention, the second insertion means may insert the telephone number of the telephone into the start-line of the header in the Invite Request to be sent to the gateway terminal.

In the server according to the second aspect of the present invention, the second insertion means may insert the telephone number of the telephone into a header field of the Invite Request to be sent to the gateway terminal.

In the server according to the second aspect of the present invention, the second insertion means may insert the telephone number of the telephone into a body of the Invite Request to be sent to the gateway terminal.

In the server according to the second aspect of the present invention, the second insertion means may insert the telephone number of the telephone into an acknowledge request to be sent to the gateway terminal.

In the server according to the second aspect of the present invention, the second insertion means may insert the telephone number of the telephone into a Real Time Control Protocol packet to be sent to the gateway terminal.

According to a third aspect of the present invention, there is provided a gateway terminal comprising: receiving means for receiving at least an Invite Request for a telephone connected to a public telephone network; and a call origination means for originating a call to the telephone based on an Invite request when the gateway terminal has received at least the Invite Request for the telephone.

The gateway terminal according to the third aspect of the present invention may further comprise a readout means for reading out a telephone number of the telephone from one of an area other than an area assigned for the URI of the gateway terminal within the start-line of the Invite Request received from the server, the area other than the start-line of the Invite Request to be sent to the gateway terminal, and the message received from the server other than the Invite Request received from the server, wherein the call origination means originates a call to the telephone by using the telephone number read out by the read out means.

In the gateway terminal according to the third aspect of the present invention, the readout means may read out the telephone number of the telephone from the start-line of the header in the Invite Request received from the server.

In the gateway terminal according to the third aspect of the present invention, the readout means may read out the telephone number of the telephone from a header field of the Invite Request received from the server.

In the gateway terminal according to the third aspect of the present invention, the readout means may read out the telephone number of the telephone from a body of the Invite Request received from the server.

In the gateway terminal according to the third aspect of the present invention, the readout means may read out the telephone number of the telephone from an acknowledge request received from the server.

In the gateway terminal according to the third aspect of the present invention, the readout means may read out the telephone number of the telephone from a Real Time Control Protocol packet received from the server.

The present invention can eliminate the use of the SIP server having a gateway function, thereby allowing a communication link between the terminal connected to an IP network and telephone connected to a public telephone network to be established at low cost.

### BRIEF DESCRIPTION OF THE DRAWINGS

FIG. 1 is a view showing a configuration of a system that implements a first conventional signaling method and a sequence of the signaling method;

FIG. 2 is a view showing a configuration of a system that implements a second conventional signaling method and a sequence of the signaling method;

FIG. 3 is a view showing a configuration of a system that implements a signaling method according to an embodiment of the present invention and a sequence of the signaling method;

FIG. 4 is a table showing a data structure of an Invite Request that a terminal according to the embodiment of the present invention sends to an SIP server;

FIG. 5 is a table showing a first example of the start-line and header field of the Invite Request that an SIP server according to a first example of the present invention sends to a gateway terminal;

FIG. 6 is a table showing a second example of the start-line and header field of the Invite Request that an SIP server according to the first example of the present invention sends to a gateway terminal;

FIG. 7 is a table showing a third example of the start-line and header field of the Invite Request that an SIP server according to the first example of the present invention sends to a gateway terminal;

FIG. 8 is a table showing a fourth example of the start-line and header field of the Invite Request that an SIP server according to the first example of the present invention sends to a gateway terminal;

FIG. 9 is a table showing a fifth example of the start-line and header field of the Invite Request that an SIP server according to the first example of the present invention sends to a gateway terminal;

FIG. 10 is a table showing a sixth example of the start-line and header field of the Invite Request that an SIP server according to the first example of the present invention sends to a gateway terminal;

FIG. 11 is a table showing a seventh example of the start-line and header field of the Invite Request that an SIP server according to the first example of the present invention sends to a gateway terminal;

FIG. 12 is a table showing an eighth example of the start-line and header field of the Invite Request that an SIP server according to the first example of the present invention sends to a gateway terminal;

FIG. 13 is a table showing a ninth example of the start-line and header field of the Invite Request that an SIP server according to the first example of the present invention sends to a gateway terminal;

FIG. 14 is a table showing a tenth example of the start-line and header field of the Invite Request that an SIP server according to the first example of the present invention sends to a gateway terminal;

FIG. 15 is a table showing an eleventh example of the start-line and header field of the Invite Request that an SIP server according to the first example of the present invention sends to a gateway terminal;

FIG. 16 is a table showing a twelfth example of the start-line and header field of the Invite Request that an SIP server according to the first example of the present invention sends to a gateway terminal;

FIG. 17 is a table showing a thirteenth example of the start-line and header field of the Invite Request that an SIP server according to the first example of the present invention sends to a gateway terminal;

FIG. 18 is a table showing a fourteenth example of the start-line and header field of the Invite Request that an SIP server according to the first example of the present invention sends to a gateway terminal;

FIG. 19 is a table showing a fifteenth example of the start-line and header field of the Invite Request that an SIP server according to the first example of the present invention sends to a gateway terminal;

FIG. 20 is a table showing a sixteenth example of the start-line and header field of the Invite Request that an SIP server according to the first example of the present invention sends to a gateway terminal;

FIG. 21 is a table showing a seventeenth example of the start-line and header field of the Invite Request that an SIP server according to the first example of the present invention sends to a gateway terminal;

FIG. 22 is a table showing an eighteenth example of the start-line and header field of the Invite Request that an SIP server according to the first example of the present invention sends to a gateway terminal;

FIG. 23 is a table showing a nineteenth example of the start-line and header field of the Invite Request that an SIP server according to the first example of the present invention sends to a gateway terminal;

FIG. 24 is a view showing a configuration of a system that implements a signaling method according to the first example of the present invention and a sequence of the signaling method;

FIG. 25 is a view showing a configuration of a system that implements a signaling method according to a second example of the present invention and a sequence of the signaling method; and

FIG. 26 is a view showing a configuration of a system that implements another signaling method according to the second example of the present invention and a sequence of the signaling method.

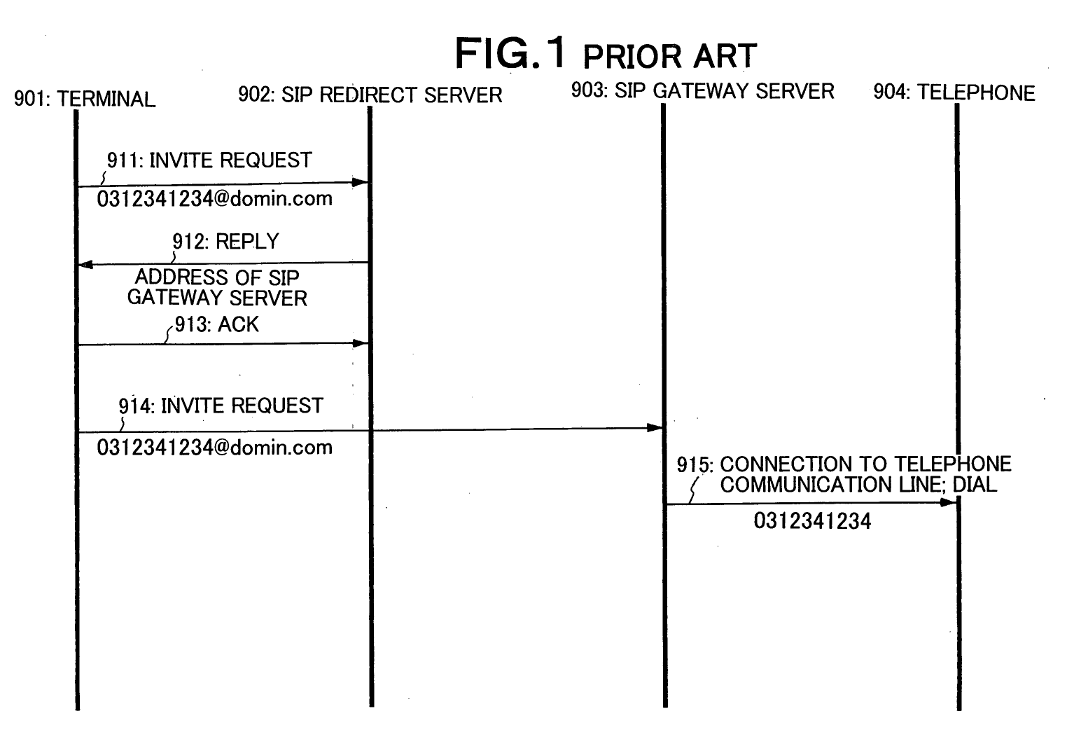

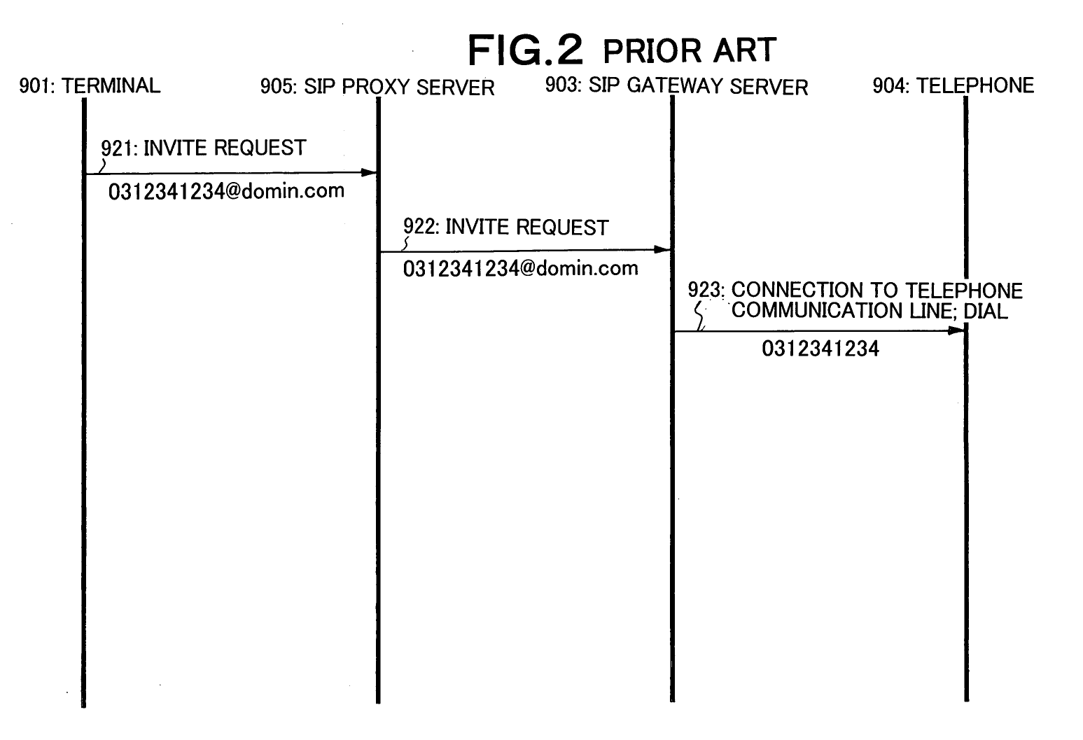

### DETAILED DESCRIPTION OF THE PREFERRED EMBODIMENTS

A preferred embodiment of the present invention will be described below in detail with reference to the accompanying drawings.

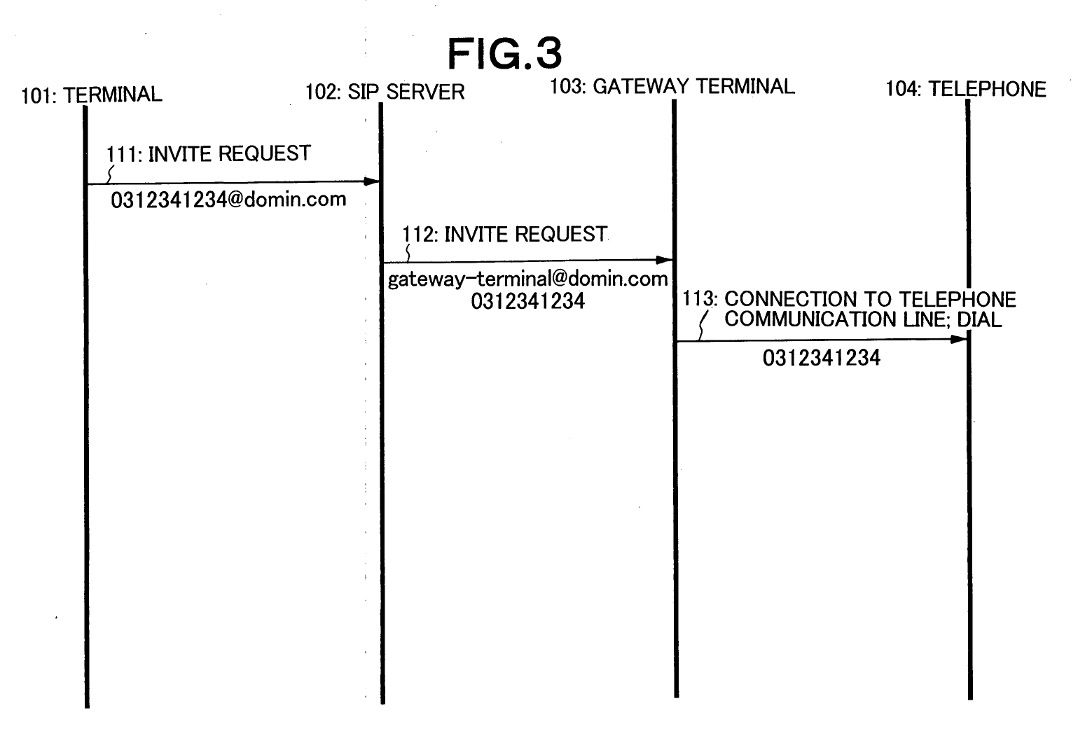

FIG. 3 is a view showing a configuration of a system that implements a signaling method according to an embodiment of the present invention and a sequence of the signaling method.

Referring to FIG. 3, when a terminal 101 makes a call to a telephone 104, firstly, the terminal 101 sends an Invite Request 111 to an SIP server 102. The start-line of the Invite Request 111 describes “0312341234@domin.com” obtained by combining “0312341234”, which is a telephone number of the telephone 104 and “domin.com”, which is a name of a domain that the terminal 101, SIP server 102 and a gateway terminal 103 belong to.

The gateway terminal is a user agent in terms of the SIP to which a gateway function is added.

Upon receiving the Invite Request 111, the SIP server 102 sends an Invite Request 112 to the gateway terminal 103. The start-line of the Invite Request 112 describes “gateway-terminal@domin.com”, which is SIP URL of the gateway terminal 103.

The SIP server 102 deletes the telephone number of the telephone 104 from the start-line of the Invite Request 112 and inserts URI of the gateway terminal 103. Alternatively, the SIP server 102 inserts the telephone number of the telephone 104 into the start-line, header field, or body of the Invite Request 112.

For example, the start-line describes a telephone number as follows: “SIP; (URI of gateway terminal) USER=Phone+(telephone number)”, or “SIP; (URI of gateway terminal) tag (telephone number)”.

The above descriptions are merely an example and are not meant to limit the description method of a telephone number in the start-line.

For example, the body describes a telephone number as follows with URI of the to-line: “SIP; (URI of gateway terminal) USER=Phone+(telephone number)”, or “SIP; (URI of gateway terminal) tag (telephone number)”.

“To URI” in the body may be described without change from the original description as follows: “TO; (telephone number)@(domain) USER=Phone”.

The above descriptions are merely an example and are not meant to limit the description method of a telephone number in header field.

Further, the SIP server 102 may insert the telephone number of the telephone 104 into a massage that the SIP server 102 sends to the gateway terminal 103 after the Invite Request 112. That is, the SIP server 102 may insert the telephone number of the telephone 104 into, for example, an ACK request or a RTCP packet.

Upon receiving the Invite Request 112, the gateway terminal 103 reads out the telephone number of the telephone 104 from the header field or body of the Invite Request 112. Alternatively, the gateway terminal 103 may read out the telephone number of the telephone 104 from a message that the gateway terminal 103 receives from the SIP server 102 after the Invite Request 112. That is, the gateway terminal 103 may read out the telephone number of the telephone 104 that has been inserted into, for example, the ACK request or the RTCP packet. The gateway terminal 103 then connects to a public telephone network and makes a call to the telephone 104 whose telephone number is “0312341234” (113).

Examples of the present invention will next be described.

### EXAMPLE 1

In the Example 1, the telephone number of the telephone is inserted into the header field of an Invite Request.

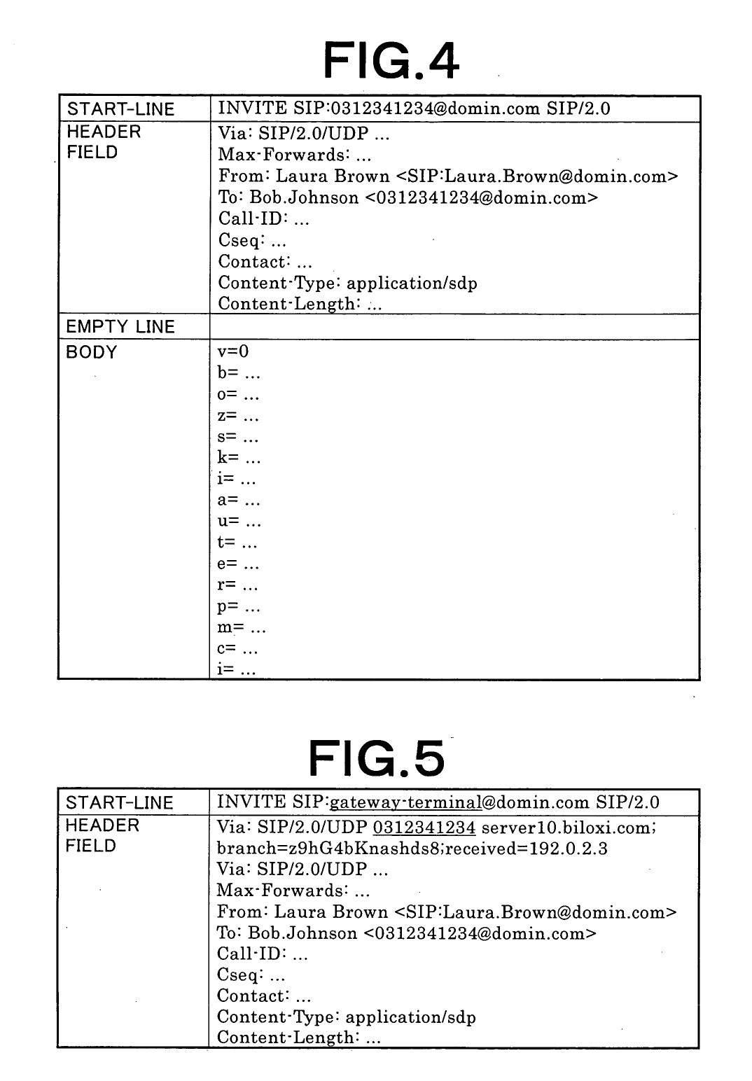

An Invite Request 111 that the terminal 101 sends to the SIP server 102 is as shown in FIG. 4. Referring to FIG. 4, the Invite Request includes a start-line, header field, empty line and body. The start-line describes “0312341234@domin.com” obtained by combining “0312341234”, which is a telephone number of the telephone and “domin.com”, which is a name of a domain that the terminal 101, SIP server 102 and gateway terminal 103 belong to.

Upon receiving the Invite Request 111, the SIP server 102 sends an Invite Request 112 to the gateway terminal 103. The start-line and header field of the Invite Request 112 are, for example, as shown in FIG. 5. Note that the Invite Request 112 and Invite Request 111 have the same body. Referring to FIG. 5, the start-line of the Invite Request 112 describes “gateway-terminal@domin.com”, which is SIP URL of the gateway terminal 103. The telephone number of the telephone 104 is inserted into an item “Via” included in the header field.

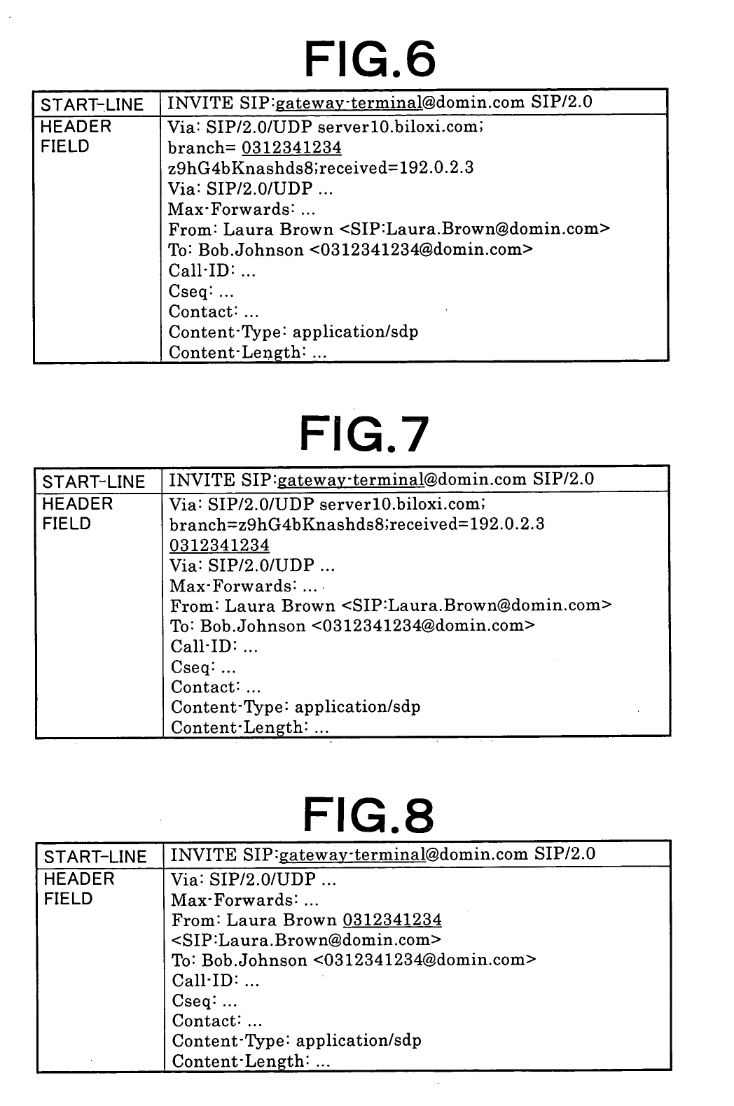

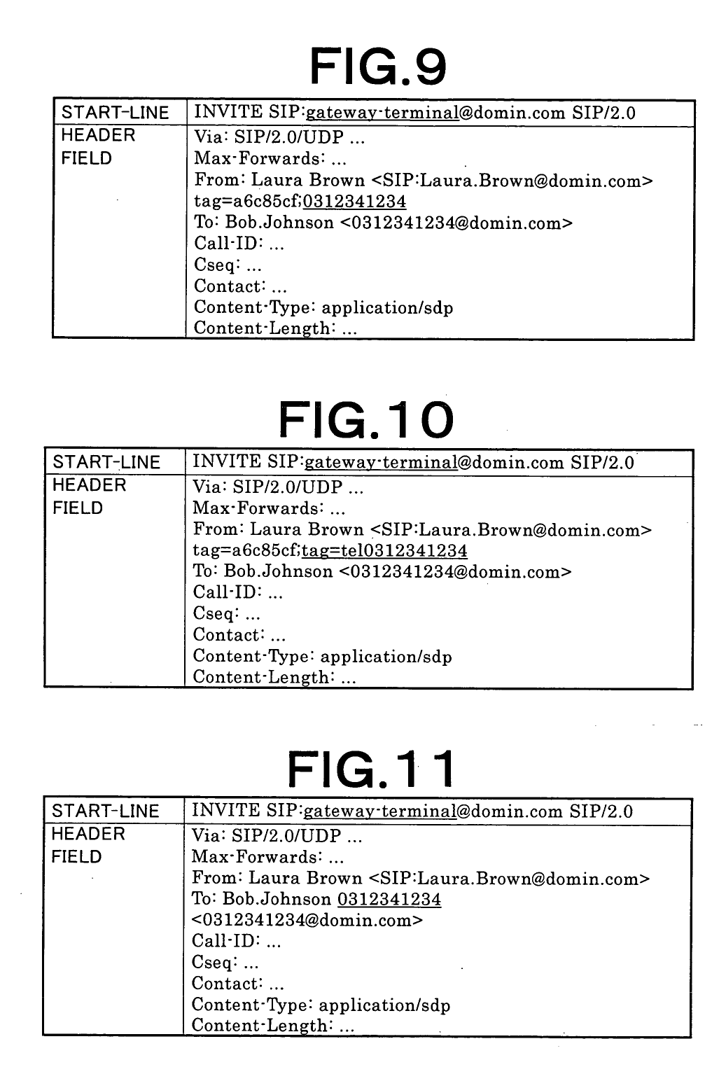

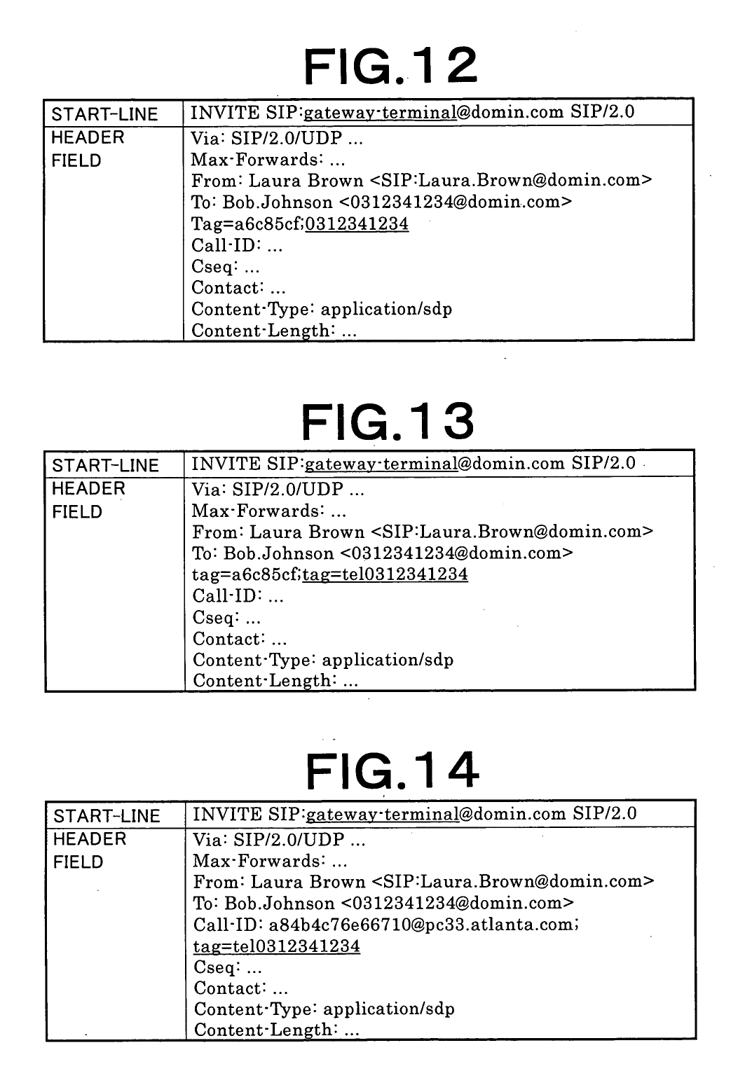

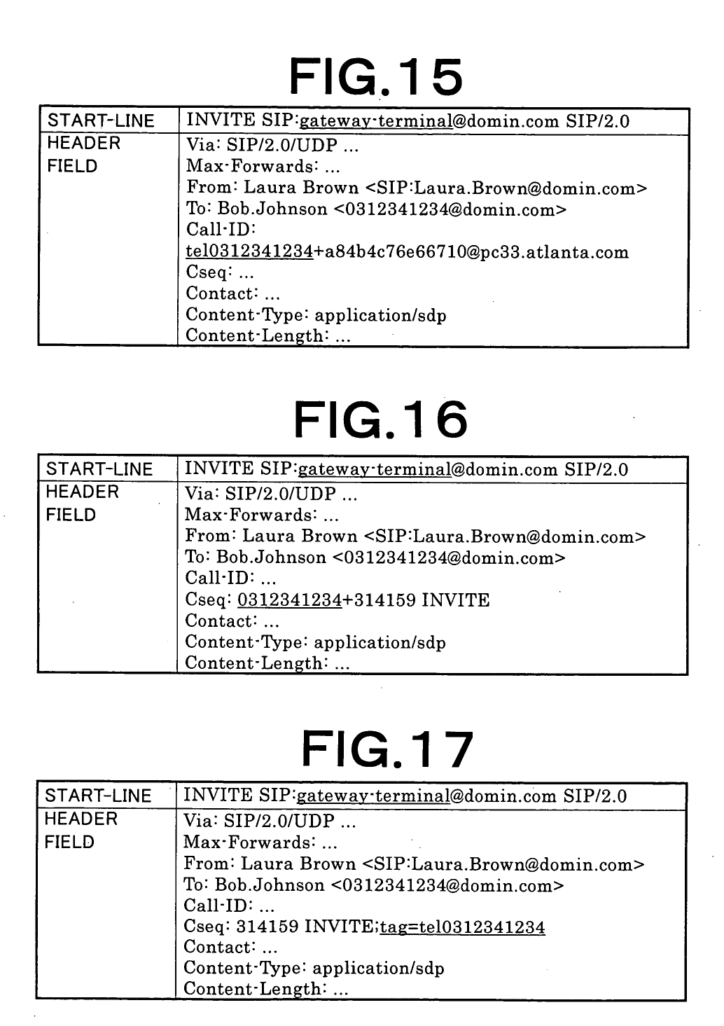

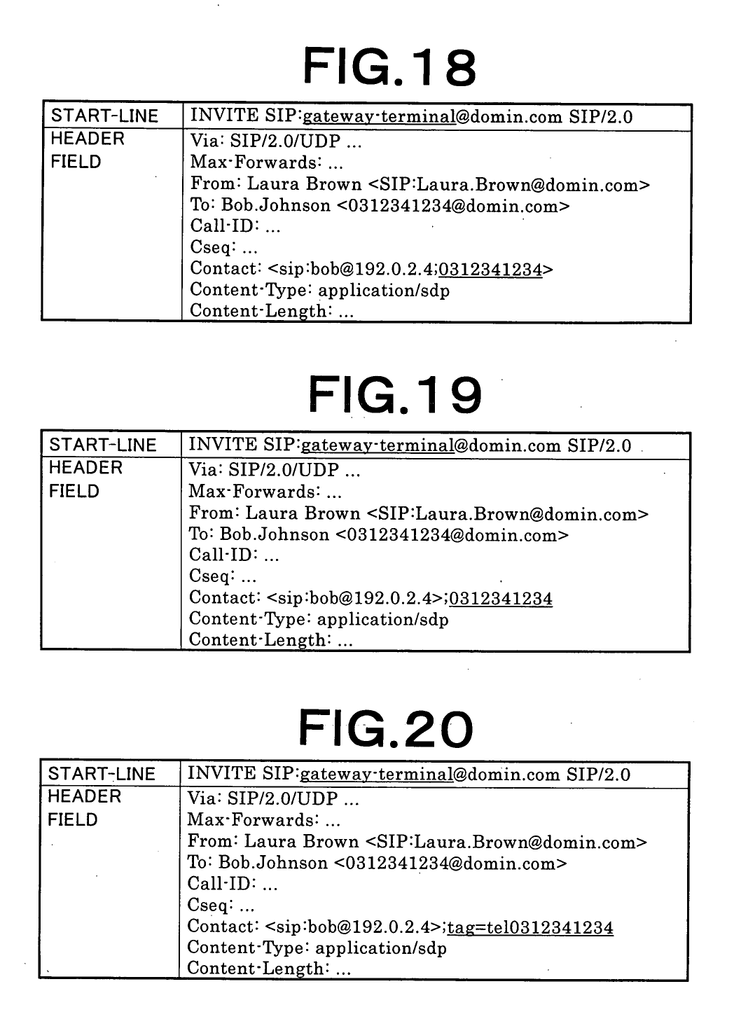

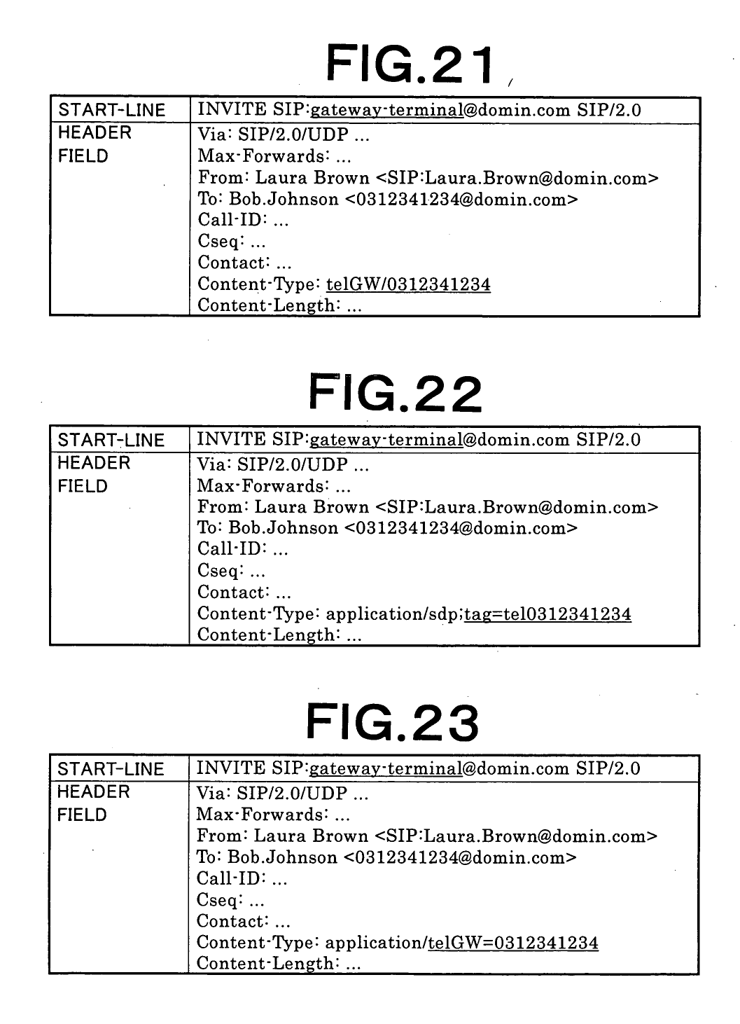

Instead of inserting the telephone number of the telephone 104 into “Via” as shown in FIG. 5, the SIP server 102 may insert the telephone number of the telephone 104 into “Via” in the manner as shown in FIG. 6 or FIG. 7. Further, the SIP server 102 may insert the telephone number of the telephone 104 into “From” as shown in FIG. 8. Further, the SIP server 102 may insert the telephone number of the telephone 104 into “From” as a second element of “tag” as shown in FIG. 9. Further the SIP server 102 may insert the telephone number of the telephone 104 into “From” as an element of “tag” in the manner as shown in FIG. 10. In FIG. 10, character string “tel” is inserted before the telephone number “0312341234” for clarification of the tag. Further, the SIP server 102 may insert the telephone number of the telephone 104 into “To” as shown in FIG. 11. Further, the SIP server 102 may insert the telephone number of the telephone 104 into “To” as a second element of “tag” as shown in FIG. 12. Further the SIP server 102 may insert the telephone number of the telephone 104 into “To” as an element of “tag” in the manner as shown in FIG. 13. In FIG. 13, character string “tel” is inserted before the telephone number “0312341234” for clarification of the tag. Further, the SIP server 102 may insert the telephone number of the telephone 104 into “Call-ID” as an element of “tag” as shown in FIG. 14 or 15. Further, the SIP server 102 may insert the telephone number of the telephone 104 into “Cseq” as shown in FIG. 16 or FIG. 17. In FIG. 17, character string “tel” is inserted before the telephone number “0312341234” for clarification of the tag. Further, the SIP server 102 may insert the telephone number of the telephone 104 into “Contact” as shown in FIG. 18, 19 or 20. In FIG. 20, character string “tel” is inserted before the telephone number “0312341234” for clarification of the tag. Further, the SIP server 102 may insert the telephone number of the telephone 104 into “Content-type” as shown in FIG. 21, 22 or 23. In FIG. 22, character string “tel” is inserted before the telephone number “0312341234” for clarification of the tag.

Upon receiving the Invite Request 112, the gateway terminal 103 reads out the telephone number of the telephone 104 that has been inserted into any of the items in the header field of the Invite Request 112. Thereafter, the gateway terminal 103 connects to a public telephone network and makes a call to a telephone 104.

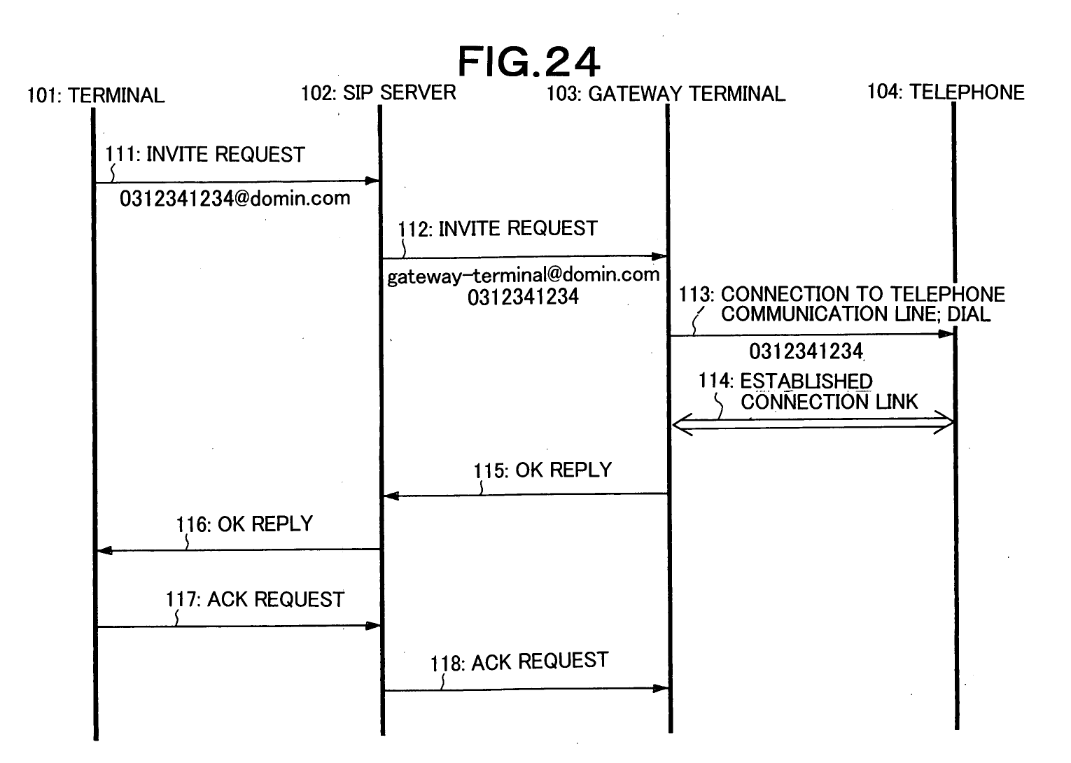

FIG. 24 is a sequence diagram showing a message sending procedure according to the Example 1. Referring to FIG. 24, the same procedure as the embodiment is performed until the gateway terminal 103 has made a call to the telephone 104.

When a communication link between the gateway terminal 103 and telephone 104 (114) has established, the gateway terminal 103 sends back an OK reply 115 to the SIP server 102. Upon receiving the OK reply 115, the SIP server 102 sends back an OK reply 116 to the terminal 101. The terminal 101 that has received the OK reply 116 then sends an acknowledge request 117 to the SIP server 102. Upon receiving the acknowledge request 117, the SIP server 102 sends an acknowledge request 118 to the gateway terminal 103.

### EXAMPLE 2

In the Example 2, the telephone number of the telephone is inserted into the body of the Invite Request.

The invite Request 111 that the terminal 101 sends to the SIP server 102 is as shown in FIG. 4. Referring to FIG. 4, the Invite Request includes a start-line, header field, empty line, and body. The start-line describes “0312341234@domin.com” obtained by combining “0312341234”, which is a telephone number of the telephone and “domin.com”, which is a name of a domain that the terminal 101, SIP server 102 and gateway terminal 103 belong to.

Upon receiving the Invite Request 111, the SIP server sends an Invite Request 112 to the gateway terminal 103. As is the case with the Example 1, the start-line of the Invite Request 112 describes as follows:
“INVITE SIP: gateway-terminal@domin.com SIP/2.0”

Like the Invite Request 111, the header field of the Invite Request 112 is as shown in FIG. 4.

The body of the Invite Request 112 has a configuration according to the present invention. The telephone number can be described in any of the items (any of v, b, . . . , i in FIG. 4) in the body of the Invite Request. Here, it is assumed that “p” that is originally used for representing a telephone number for obtaining session information is used in order to distinguish the description of a telephone number according to the present invention from that of an original item value. In the original case, a telephone number is described using the “p” as:
P=0334311831
   whereas, a telephone number is described in the case of the present invention as:
p=<sip:0312341234@domin.com;user=phone>.

The gateway terminal 103 has been designed according to the present invention and can distinguish between the original item value and telephone number according to the present invention even in the case where they are described in the same item by determining the format.

Upon receiving the Invite Request 112, the gateway terminal 103 reads out the telephone number of the telephone 104 that has been inserted into any of the items in the body of the Invite Request 112. Thereafter, the gateway terminal 103 connects to a public telephone network and makes a call to the telephone 104.

### EXAMPLE 3

In the Example 3, the telephone number of the telephone is inserted into the header field of the acknowledge request.

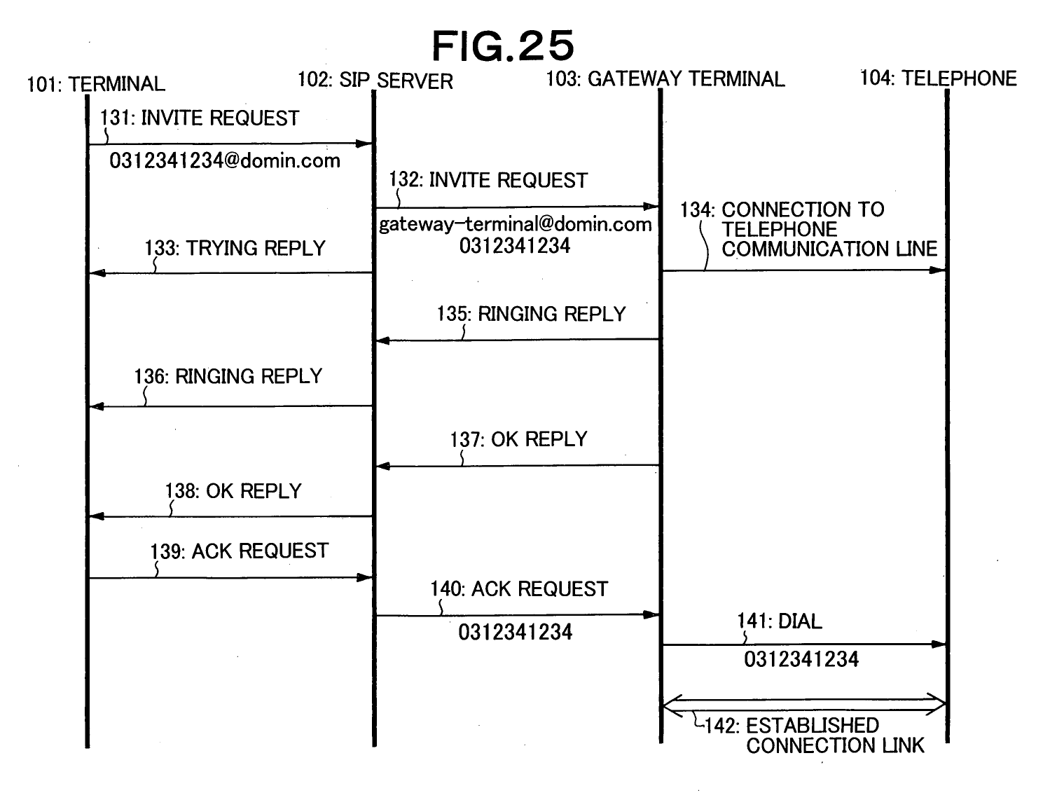

FIG. 25 is a sequence diagram showing a message sending procedure according to the Example 3.

Referring to FIG. 25, the terminal 101 sends an Invite Request 131 to the SIP server 102. The start-line of the Invite Request 131 describes “0312341234@domin.com”. Upon receiving the Invite Request 131, the SIP server 102 sends an Invite Request 132 to the gateway terminal 103. The start-line of the Invite Request 132 describes “gateway-terminal@domin.com”. Unlike the case of the Examples 1 and 2, the telephone number of the telephone 104 is not inserted into the header field and body of the Invite Request 112. Upon receiving the Invite Request 131, the SIP server 102 further sends back a TRYING reply 133 to the terminal 101. The gateway terminal 103 that has received the Invite Request 132 connects to a public telephone network (134) and sends back a ringing reply 135 to the SIP server 102. Upon receiving the ringing reply 135, the SIP server 102 sends back a ringing reply 136 to the terminal 101. Thereafter, gateway terminal 103 sends back an OK reply 137 to the SIP server 102. Upon receiving the OK reply 137, the SIP server 102 sends back an OK reply 138 to the terminal 101. Upon receiving the OK reply 138, the terminal 101 sends an acknowledge request 139 to the SIP server 102. Upon receiving the acknowledge request 139, the SIP server 102 sends an acknowledge request 140 to the gateway terminal 103. The telephone number of the telephone 104, that is, “0312341234” is inserted into the acknowledge request 140. Upon receiving the acknowledge request 140, the gateway terminal 103 reads out the telephone number of the telephone 104 from the acknowledge request 140 and makes a call to the telephone 104 (141). Thereafter, a communication link between the gateway terminal 103 and telephone 104 is established (142).

When the link establishment has failed, the gateway terminal 103 sends a request error, server error, or global error to the terminal 101.

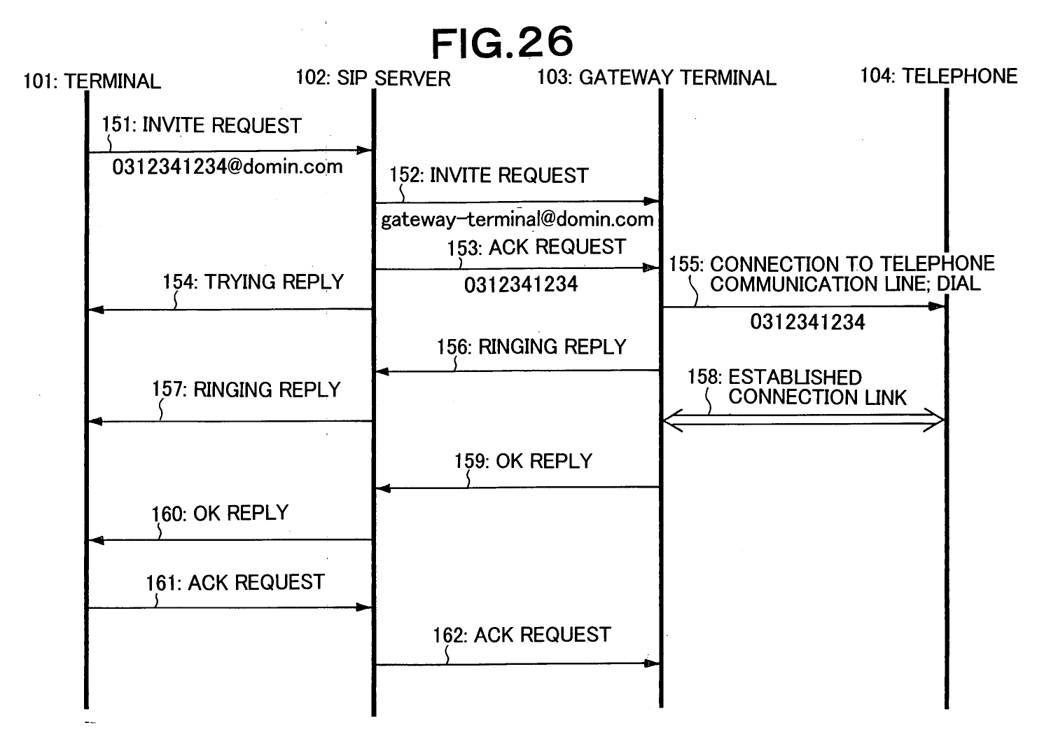

FIG. 26 is a sequence diagram showing another message sending procedure according to the Example 3.

Referring to FIG. 26, the terminal 101 sends an Invite Request 151 to the SIP server 102. The start-line of the Invite Request 151 describes “0312341234@domin.com”. Upon receiving the Invite Request 151, the SIP server 102 sends an Invite Request 152 to the gateway terminal 103. The start-line of the Invite Request 152 describes “gateway-terminal@domin.com”. Unlike the case of Examples 1 and 2, the telephone number of the telephone 104 is not inserted into the header field and body of the Invite Request 152. Subsequently, the SIP server 102 sends an acknowledge request 153 to the gateway terminal 103. The telephone number of the telephone 104, that is, “0312341234” is inserted into the acknowledge request 153. The SIP server 102 then sends a TRYING reply 154 to the terminal 101. The gateway terminal 103 that has received the acknowledge request 153 reads out the telephone number from the acknowledge request 153, then connects to a public telephone network and makes a call to the telephone 104 (155). Subsequently, the gateway terminal 103 sends back a ringing reply 156 to the SIP server 102. Upon receiving the ringing reply 156, the SIP server 102 sends back a ringing reply 157 to the terminal 101. When a communication link between the gateway terminal 103 and telephone 104 has been established (158), the gateway terminal 103 sends back an OK reply 159 to the SIP server 102. Upon receiving the OK reply 159, the SIP server 102 sends back an OK reply 160 to the terminal 101. Upon receiving the OK reply 160, the terminal 101 sends an acknowledge request 161 to the SIP server 102. Upon receiving the acknowledge request 161, the SIP server 102 sends an acknowledge request 162 to the gateway terminal 103.

When the link establishment has failed, the gateway terminal 103 does not send back the OK reply 159 to the SIP server 102.

The manner of inserting the telephone number of the telephone into the header field of the acknowledge request 140 or 153 is the same as the manner of inserting the telephone number into the header field of the Invite Request in the Example 1. Therefore, the header field of the acknowledge request 140 or 153 has the structure as shown in FIGS. 5 to 23.

### EXAMPLE 4

In the Example 4, the telephone number of the telephone 104 is inserted into a predetermined region of the profile-specific extensions in a Receiver Report RTCP Packet described in chapter of 6.2.4 of the RFC3550 written standards.

The SIP server 102 may send the telephone number of the telephone 104 to the gateway terminal 103 by using a message other than a message for signaling.

### EXAMPLE 5

In the Example 5, the SIP server 102 and gateway terminal 103 are built in the same information equipment.

The present invention can be utilized for establishing a communication connection between a terminal connected to an IP network and a telephone connected to a public telephone network.

Further, the present invention can be used for the communication connection to the dedicated line for an enterprise telephone system or a VoIP carrier service. Further, the communication medium is not limited to a telephone and the present invention can also be applied to other media, such as a video conferencing stream or e-mail.

1. A signaling method comprising:
a transfer step in which, when having received an Invite Request for a telephone connected to a public telephone network, a server transfers the Invite Request to a gateway terminal; and
a call origination step in which, when having received at least the Invite Request, the gateway terminal originates a call to the telephone.

2. The signaling method according to claim 1, further comprising:
a readout step in which the server reads out a telephone number of the telephone from the received Invite Request;
an insertion step in which the server inserts a URI of the gateway terminal into a start-line of the received Invite Request; and
an insertion step in which the server inserts the telephone number of the telephone into one of an area other than an area assigned for the URI of the gateway terminal within the start-line of the Invite Request to be sent to the gateway terminal, an area other than the start-line of the Invite Request to be sent to the gateway terminal, and a message to be sent to the gateway terminal other than the Invite Request sent to the gateway terminal.

3. The signaling method according to claim 2, further comprising a readout step in which the gateway terminal reads out the telephone number of the telephone from one of the start-line of the Invite Request received from the server, the area other than the start-line, and the message received from the server other than the Invite Request from the server, wherein
the gateway terminal originates, in the call origination step, a call to the telephone by using the telephone number that has been read out in the readout step.

4. The signaling method according to claim 1, further comprising an insertion step in which the server inserts the telephone number of the telephone into the start-line of the header in the Invite Request to be sent to the gateway terminal.

5. The signaling method according to claim 4, further comprising a readout step in which the gateway terminal reads out the telephone number of the telephone from the start-line of the header in the Invite Request received from the server, wherein
the gateway terminal originates, in the call origination step, a call to the telephone by using the telephone number that has been read out in the readout step.

6. The signaling method according to claim 1, further comprising an insertion step in which the server inserts the telephone number of the telephone into a header field of the Invite Request to be sent to the gateway terminal.

7. The signaling method according to claim 6, further comprising a readout step in which the gateway terminal reads out the telephone number of the telephone from the header field of the Invite Request received from the server, wherein
the gateway terminal originates, in the call origination step, a call to the telephone by using the telephone number that has been read out in the readout step.

8. The signaling method according to claim 1, further comprising an insertion step in which the server inserts the telephone number of the telephone into a body of the Invite Request to be sent to the gateway terminal.

9. The signaling method according to claim 8, further comprising a readout step in which the gateway terminal reads out the telephone number of the telephone from the body of the Invite Request received from the server, wherein
the gateway terminal originates, in the call origination step, a call to the telephone by using the telephone number that has been read out in the readout step.

10. The signaling method according to claim 1, further comprising an insertion step in which the server inserts the telephone number of the telephone into an acknowledge request to be sent to the gateway terminal.

11. The signaling method according to claim 10, further comprising a readout step in which the gateway terminal reads out the telephone number of the telephone from the acknowledge request received from the server, wherein
the gateway terminal originates, in the call origination step, a call to the telephone by using the telephone number that has been read out in the readout step.

12. The signaling method according to claim 1, further comprising an insertion step in which the server inserts the telephone number of the telephone into a Real Time Control Protocol packet to be sent to the gateway terminal.

13. The signaling method according to claim 12, further comprising a readout step in which the gateway terminal reads out the telephone number of the telephone from the Real Time Control Protocol packet received from the server, wherein
the gateway terminal originates, in the call origination step, a call to the telephone by using the telephone number that has been read out in the readout step.

14. A server comprising:
receiving means for receiving an Invite Request for a telephone connected to a public telephone network; and
transfer means for transferring the Invite Request to a gateway terminal when the server has received the Invite Request.

15. The server according to claim 14, further comprising:
readout means for reading out a telephone number of the telephone from the received Invite Request;
first insertion means for inserting a URI of the gateway terminal into a start-line of the received Invite Request;
second insertion means for inserting the telephone number of the telephone into one of an area other than an area assigned for the URL of the gateway terminal within the start-line of the Invite Request to be sent to the gateway terminal, an area other than the start-line of the Invite Request to be sent to the gateway terminal, and a message to be sent to the gateway terminal other than the Invite Request sent to the gateway terminal.

16. The server according to claim 15, wherein the second insertion means inserts the telephone number of the telephone into the start-line of the header in the Invite Request to be sent to the gateway terminal.

17. The server according to claim 15, wherein the second insertion means inserts the telephone number of the telephone into a header field of the Invite Request to be sent to the gateway terminal.

18. The server according to claim 15, wherein the second insertion means inserts the telephone number of the telephone into a body of the Invite Request to be sent to the gateway terminal.

19. The server according to claim 15, wherein the second insertion means inserts the telephone number of the telephone into an acknowledge request to be sent to the gateway terminal.

20. The server according to claim 15, wherein the second insertion means inserts the telephone number of the telephone into a Real Time Control Protocol packet to be sent to the gateway terminal.

21. A gateway terminal comprising:
receiving means for receiving at least an Invite Request for a telephone connected to a public telephone network; and
call origination means for originating a call to the telephone based on the Invite request when the gateway terminal has received at least the Invite Request for the telephone.

22. The gateway terminal according to claim 21, further comprising readout means for reading out a telephone number of the telephone from one of an area other than an area assigned for the URI of the gateway terminal within the start-line of the Invite Request received from the server, an area other than the start-line of the Invite Request received from the server, and the message received from the server other than the Invite Request received from the server, wherein
the call origination means originates a call to the telephone by using the telephone number read out by the read out means.

23. The gateway terminal according to claim 21, wherein the readout means reads out the telephone number of the telephone from the start-line of the header in the Invite Request received from the server.

24. The gateway terminal according to claim 22, wherein the readout means reads out the telephone number of the telephone from a header field of the Invite Request received from the server.

25. The gateway terminal according to claim 22, wherein the readout means reads out the telephone number of the telephone from a body of the Invite Request received from the server.

26. The gateway terminal according to claim 22, wherein the readout means reads out the telephone number of the telephone from an acknowledge request received from the server.

27. The gateway terminal according to claim 22, wherein the readout means reads out the telephone number of the telephone from a Real Time Control Protocol packet received from the server.
